(19) United States
(12) Patent Application Publication
(10) Pub. No.: US 2019/0378098 A1
(43) Pub. Date: Dec. 12, 2019

(54) SYSTEMS AND METHODS OF TRANSACTION ROUTING

(71) Applicant: Pungle Inc., Burlington (CA)

(72) Inventors: Braulio Martin Lam, Burlington (CA); Stanislav Rolf Karl Fabricius, Toronto (CA); Paul Eric Birkness, Richmond Hill (CA)

(21) Appl. No.: 16/437,050

(22) Filed: Jun. 11, 2019

Related U.S. Application Data
(60) Provisional application No. 62/683,409, filed on Jun. 11, 2018.

(51) Int. Cl. G06Q 20/08; G06N 20/00; G06N 7/00; G06K 9/62; H04L 12/751

(52) U.S. Cl. CPC G06Q 20/085; G06N 20/00; H04L 45/08; G06K 9/6262; G06N 7/00

(57) ABSTRACT

A transaction router system and method that involves building a machine learning model using a Markov Decision Process (MDP), and then building a reinforcement learning solution to the model. The system and method accept transaction requests from a software application via an Application Programming Interface (API), via a mobile application, or via a web interface and allow a user to specify different criteria for processing the transaction including network speed, price, compliance, geography, and reliability and then determines a preferred payment network based on the historical transaction data for the transaction router.

### CROSS-REFERENCE TO RELATED APPLICATION

This application claims priority to U.S. Provisional Application No. 62/683,409 filed on Jun. 11, 2018, the entire contents of which are hereby incorporated herein by reference.

### FIELD

The described embodiments relate to the transaction routing of online payment transfers.

### BACKGROUND

The processing of transactions on the internet is remarkably complicated. A payor intends to send money to a payee. To make the payment, the payor generally uses a web-based software application. The operator of the web-payment application integrates their system with a payment gateway provided by a payment network operator. The payment gateway may be provided via an Application Programming Interface (API), and the operator of the web-based application may require a merchant account with the payment network. The operator of the web-payment application may direct the transaction to the payment network. The payment network may validate the account credentials (whether credit card or otherwise), determine whether there are sufficient funds to cover the payment at payor's bank, and if so, the payment network may authorize the transaction.

The payment gateway may offer a variety of different features, including differential fees (including monthly fees, transaction fees, setup fees, and chargeback fees), differing payment methods (such as VISA@ or MASTERCARD®), transactions in different currencies, transactions to payees in different geographic locations, differing levels of legal compliance (for instance with the Processing Card Industry Data Security Standards), and differing levels of reliability. The payment network may receive the transaction from the web-payment application, and process the payment from the payor's account to the payee's account.

The number of different payment gateways means that it is very challenging to automatically and efficiently determine which one is the most cost efficient for a payor, which one has the greatest geographic reach to a payee, or which supports the features desired and route the transaction accordingly.

### SUMMARY

In a first aspect, there is provided a method of routing a transaction at a server system from a client system to a destination payment network in a plurality of payment networks, the plurality of payment networks in network communication with the server system, comprising: providing, at the server system, a machine learning routing model, the machine learning routing model comprising: a plurality of states defining a state space, the state space having a plurality of dimensions; a plurality of actions corresponding to the plurality of payment networks; a plurality of state transition tables; and at least one reward function, receiving, from the client system, a transaction request, the transaction request comprising a plurality of data, wherein the plurality of data comprises transaction data and transaction metadata; determining, at the server system, the destination payment network by: determining a routing decision from the machine learning routing model based on the transaction request and the machine learning routing model, wherein the routing decision is determined based on the at least one reward function calculated for each action in the plurality of actions, creating, at the server system, a transaction corresponding to the transaction request, the transaction comprising at least a payor, a payee, a transaction price, a transaction status, and a transaction time; transmitting the transaction to the destination payment network corresponding to the routing decision.

In at least one embodiment, the method may further comprise: creating, at the server system, a transaction response corresponding to the transaction request and a response of the destination payment network to the transaction; and transmitting the transaction response to the client system.

In at least one embodiment, the method may further comprise: storing, at a database of the server system, the transaction request, the transaction, and the transaction response.

In at least one embodiment, the state space may have at least a price dimension corresponding to the transaction price, a network speed dimension corresponding to the transaction time, a reliability dimension corresponding to the transaction status, a compliance dimension, and a geographic dimension.

In at least one embodiment, each state transition table in the plurality of state transition tables may comprise a plurality of state transition entries, each state transition entry describing a probability of a state transition from a first state to a second state for a given action.

In at least one embodiment, the determining the routing decision may comprise: for each action in the plurality of actions, determining an expected action score via reinforcement learning; selecting the action having the highest expected action score as the routing decision.

In at least one embodiment, the determining an expected action score may further comprise evaluating Σₛ, Pₐ(s,s′)(Rₐ(s, s′)+γV(s′)), wherein Pₐ(s, s′) may be a probability of an action transitioning a transaction from states to s′, Rₐ(s, s′) may be a reward of transitioning from state s to s′ calculated based on the at least one reward function, and γV(s′) may be a discounted future action score.

In at least one embodiment, the method may further comprise determining the routing decision based on the at least one, each reward function being a weighted linear combination of state components.

In at least one embodiment, the payment network may be modelled using a Markov Decision Process.

In a second aspect, there is provided a transaction routing system for routing a transaction at a server system from a client system to a destination payment network in a plurality of payment networks, the plurality of payment networks in network communication with the server system, comprising: a processor unit of the server system; and a memory unit of the server system coupled to the processor unit, the memory unit storing instructions executable by the processor unit; the processor unit being configured to: provide a machine learning routing model, the machine learning routing model comprising: a plurality of states defining a state space, the state space having a plurality of dimensions; a plurality of actions corresponding to the plurality of payment networks; a plurality of state transition tables; and at least one reward function, receive a transaction request from the client system, the transaction request comprising a plurality of data, wherein the plurality of data comprises transaction data and transaction metadata; determine a routing decision from the machine learning routing model based on the transaction request and the machine learning routing model, wherein the routing decision is determined based on the reward score calculated based on the at least one reward function for each action in the plurality of actions; create a transaction corresponding to the transaction request, the transaction comprising at least a payor, a payee, a transaction price, a transaction status, and a transaction time; and transmit the transaction to the destination payment network corresponding to the routing decision.

In at least one embodiment, the processor may be further configured to: create a transaction response corresponding to the transaction request and a response of the destination payment network to the transaction; and transmit the transaction response to the client system.

In at least one embodiment, the processor may be further configured to: storing, at a database in the memory unit, the transaction request, the transaction, and the transaction response.

In at least one embodiment, the state space may have at least a price dimension corresponding to the transaction price, a network speed dimension corresponding to the transaction time, a reliability dimension corresponding to the transaction status, a compliance dimension, and a geographic dimension.

In at least one embodiment, the system may further comprise: the processor unit being further configured: wherein each state transition table in the plurality of state transition tables may comprise a plurality of state transition entries, each state transition entry may describe a probability of a state transition from a first state to a second state for a given action.

In at least one embodiment, the system may further comprise: the processor unit may be further configured: wherein the determining the routing decision comprises: for each action in the plurality of actions, determining an expected action score; select the action having the highest expected action score as the routing decision.

In at least one embodiment, the system may further comprise: the processor unit may be further configured to: determine an expected action score further comprises evaluating Σₛ, Pₐ(s, s′)(Rₐ(s, s′)+γV(s′)), wherein Pₐ(s, s′) may be a probability of an action transitioning a transaction from state s to s′, Rₐ(s, s′) may be the reward of transitioning from state s to s′ calculated based on the at least one reward function, and γV(s′) may be a discounted future action score.

In at least one embodiment, the system may further comprise: the processor unit may be further configured to: determine the routing decision based on a weighted combination of state components.

In at least one embodiment, the transaction may be stored in a database in network communication with the processor unit.

In at least one embodiment, the payment network may be modelled using a Markov Decision Process.

In a third aspect, there is provided a method of creating a machine learning routing model for routing a transaction to a destination payment network in a plurality of payment networks at, comprising: providing, in a database, a plurality of historical transactions; creating, at the server system, a plurality of vector representations corresponding to the plurality of historical transactions; creating, at the server system, a plurality of states defining a state space from the plurality of vector representations, and the state space having a plurality of dimensions; sorting, at the server system, the plurality of vector representations into the plurality of states; determining, at the server system, a plurality of state transition tables from the sorted plurality of vector representations, the plurality of state transition tables for routing a transaction based on a transaction routing decision to the destination payment network in the plurality of payment networks; storing, in the database, the plurality of state transition tables.

In at least one embodiment, the state space may have at least a price dimension corresponding to a transaction price, a network speed dimension corresponding to a transaction time, a reliability dimension corresponding to a transaction status, a compliance dimension, and a geographic dimension.

In at least one embodiment, each state transition table in the plurality of state transition tables may further comprise a plurality of state transition entries, each state transition entry may identify a single probability of transition from an initial state s to a next state s′ for a given action.

In at least one embodiment, the method may further comprise: determining a probability of a state transition entry by: determining a number of historical transactions that have occurred between a state s and a state s′ for an action; determining a total number of transactions associated with the action; and dividing the number of historical transactions that have occurred between a state s and a state s′ by the total number of transactions associated with the action.

In at least one embodiment, the method may further comprise: reducing the state space by removing states having zero transactions; and reducing the number of states by combining states having generally similar components.

In at least one embodiment, the method may further comprise: each of the plurality of historical transactions comprising: transaction data; transaction metadata; and transaction status, each vector representation in the plurality of vector representations is determined from a network speed data, a geographic data, a price data, a reliability data, and a compliance data from the plurality of historical transactions.

In a fourth aspect, there is provided a machine learning routing model system for creating a machine learning routing model for routing a transaction to a destination payment network in a plurality of payment networks, comprising: a processor unit; a memory unit coupled to the processor unit, the memory unit storing instructions executable by the processor unit; the processor unit being configured to: provide a plurality of historical transactions; create a plurality of vector representations corresponding to the plurality of historical transactions; create a plurality of states defining a state space from the plurality of vector representations, and the state space having a plurality of dimensions; sort the plurality of vector representations into the plurality of states, determine a plurality of state transition tables from the sorted plurality of vector representations, the plurality of state transition tables for routing a transaction based on a transaction routing decision to the destination payment network in the plurality of payment networks; and store the plurality of state transition tables.

In at least one embodiment, the state space may have at least a price dimension corresponding to a transaction price, a network speed dimension corresponding to a transaction time, a reliability dimension corresponding to a transaction status, a compliance dimension, and a geographic dimension.

In at least one embodiment, each state transition table in the plurality of state transition tables may further comprise a plurality of state transition entries, each state transition entry identifying a single probability of transition from an initial state s to a next state s′ for a given action.

In at least one embodiment, the processor unit may be further configured to: determine a probability of a state transition entry by: determining a number of historical transactions that have occurred between a state s and a state s′ for the action; determining the total number of transactions associated with the action, divide the number of historical transactions that have occurred between a state s and a state s′ by the total number of transactions associated with the action.

In at least one embodiment, the processor unit may be further configured to: reducing the state space by removing states having zero transactions, and reducing the number of states by combining states having generally similar components.

In at least one embodiment, each of the plurality of historical transactions may comprise: transaction data; transaction metadata; and transaction status, each vector representation in the plurality of vector representations is determined from a network speed data, a geographic data, a price data, a reliability data, and a compliance data from the plurality of historical transactions.

### BRIEF DESCRIPTION OF THE DRAWINGS

A preferred embodiment of the present invention will now be described in detail with reference to the drawings, in which:

FIG. 1A is a diagram of the transaction router system in accordance with an example embodiment.

FIG. 1B is a diagram of a server running the transaction router in accordance with an example embodiment.

FIG. 2 is a block diagram of components interacting with a transaction router in accordance with an example embodiment.

FIG. 3 is a software component diagram of a transaction router in accordance with an example embodiment.

FIG. 4 is a software component diagram of the learning engine of the transaction router of FIG. 3.

FIG. 5 is a state space diagram of a learning engine in accordance with an example embodiment.

FIG. 6 is a transaction table illustrating exemplary data related to at least some transactions sent from a payor to a payee, in accordance with an example embodiment.

FIG. 7 is a flowchart of an example embodiment of various methods of routing payment transfers using a transaction router.

FIG. 8 is a flowchart of an example embodiment of various methods of routing payment transfers using a transaction router.

FIG. 9 is a representation of operational statistics of various aspects of network speed metrics for the historical transaction data, in accordance with an example embodiment.

FIG. 10 is a representation of supported geographical jurisdictions of various payment networks, in accordance with an example embodiment.

FIG. 11 is a representation of operational statistics of various aspects of price metrics for the historical transaction data, in accordance with an example embodiment.

FIG. 12 is a representation of operational statistics of various aspects of error rate metrics for the historical transaction data, in accordance with an example embodiment.

FIG. 13 is a representation of supported compliance standards of various payment networks, in accordance with an example embodiment.

FIG. 14 is a flowchart of an example embodiment of creating a machine learning routing model, in accordance with an example embodiment.

FIG. 15 is a screenshot of a dashboard interface in accordance with an example embodiment.

FIG. 16 is a screenshot of a transfer request interface in accordance with an example embodiment.

FIG. 17A is a screenshot of a payor preference interface in accordance with an example embodiment.

FIG. 17B is a screenshot of a user selecting a payor preference interface in accordance with an example embodiment.

FIG. 18A is a screenshot of a completed payor preference interface in accordance with an example embodiment.

FIG. 18B is a screenshot of a payor preference interface in accordance with an example embodiment.

### DESCRIPTION OF EXEMPLARY EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smartphone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural, a functional language, or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

A transaction may be completed by taking multiple steps and may result in the transaction arriving in a plurality of states. The embodiments disclosed herein may refer to the use of a Markov Decision Process (MDP) to model such a transaction routing problem, the MDP may provide a mathematical model for decision making in circumstances having outcomes that are partially random and partly under control of the decision maker and where the transitions between different states are suitable to be modelled. The routing problem, being modelled or framed as an MDP problem, may be solved using a reinforcement learning solution. The solution given by the reinforcement learning solution may be transaction router system and method where an agent takes an action to arrive at a state and based on a reward. An MDP is a useful way model a system where different decisions may be taken in order to arrive at a proposed optimal decision or policy. The general scenario for an MDP is that an agent is in a first state, and may take an action. In an example, when in a state, s, the decision maker may take an action, a₁ or a₂ that are available to s. By defining a reward for each state, an MDP may refer to an optimal policy, or an optimal mapping of states to actions. Solving an MDP leads to a policy that maximizes a reward function to determine the optimal policy.

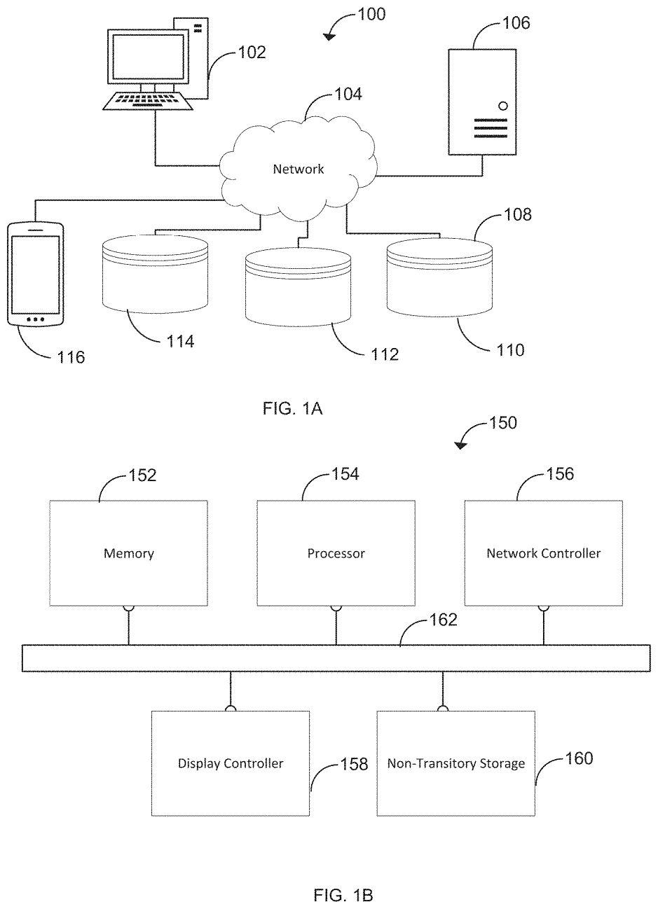

Reference is first made to FIG. 1A, which illustrates a transaction router 100. The transaction router may run on a server 106, connected via a network 104 to a client system 102.

The network 104 may be the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the server 106, the client system 102 and 116, transactions database 114, real-time exchange rates database 112, and compliance database 110.

The transaction database 114 may be provided by a database server, and may contain the historical transactions processed by the transaction router 100. The real-time exchange rates database 112 may be provided by a database server, or may be a 3^{rd} party service delivered via an API. The content of the real-time exchange rates database 112 may include exchange rate information between a plurality of currencies. The compliance database 110 may be provided by a database server, and may include information relating to the features of a plurality of payment gateways. The compliance database 110 may be provided by a database server, or may be a 3^{rd} party service delivered via an API.

The transactions database 114, real-time exchange rates database 112, and compliance database 110 may run on a relational database management product (RDBMS) such as Postgres™, MySQL®, ORACLE®, or DB2®, and may run on server 106 or on an independent database server (not shown).

Server 106 may have an application server and/or a web server running on it that delivers a web-based interface to the transaction router 100 to the client system 102 and 116 via network 104. Alternatively, the client system 102 may have a client application installed on it and may connect to the server 106 in a client-server model.

The server 106 may run a learning engine on the application server that may provide for decision making in the routing of transactions. The server 106 may provide an API interface available over network 104 to users such that another software application may integrate with it and thus may itself function as a payment gateway.

The client system 102 may be a personal computer, a smartphone 116, an electronic tablet device, a laptop, a workstation, server, portable computer, mobile device, personal digital assistant, Wireless Application Protocol (WAP) phone, an interactive television, video display terminals, gaming consoles, and portable electronic devices. The client systems 102 and 116 may have a browser pre-installed, such as Google® Chrome®, Mozilla® Firefox®, or Microsoft® Internet Explorer®.

Reference is first made to FIG. 1B, showing a block diagram 150 of server 106 running the transaction router and/or learning engine. Server 106 has memory 152, processor 154, network controller 156, display controller 158, non-transitory storage 160, and system bus 162.

The processor 154 can generally control the operation of the transaction router. The processor 154 may also determine, based on received data, stored data and/or user preferences, how the transaction router may generally operate.

The processor 154 may be any suitable one or more processors that can provide processing power depending on the configuration and use of the transaction router application. In some embodiments, the processor 154 can include more than one processor with each processor being configured to perform different dedicated tasks. Processor 154 may be, for example, an Intel® Xeon®, or AMD® Opteron™.

The learning engine and transaction router can be operated by the processor 154 for determining how transactions should be routed between different payment gateways. Operation of the transaction router will be described further below.

The network controller 156 may be any interface that enables the server 106 to communicate with other devices and systems. In some embodiments, the network controller 156 can include a serial port, a parallel port, and/or a Universal Serial Bus (USB) port. The network controller 156 may also include at least one of an Internet, Local Area Network (LAN), Ethernet, Firewire, modem, or digital subscriber line connection. Various combinations of these elements may be incorporated within the network controller 156.

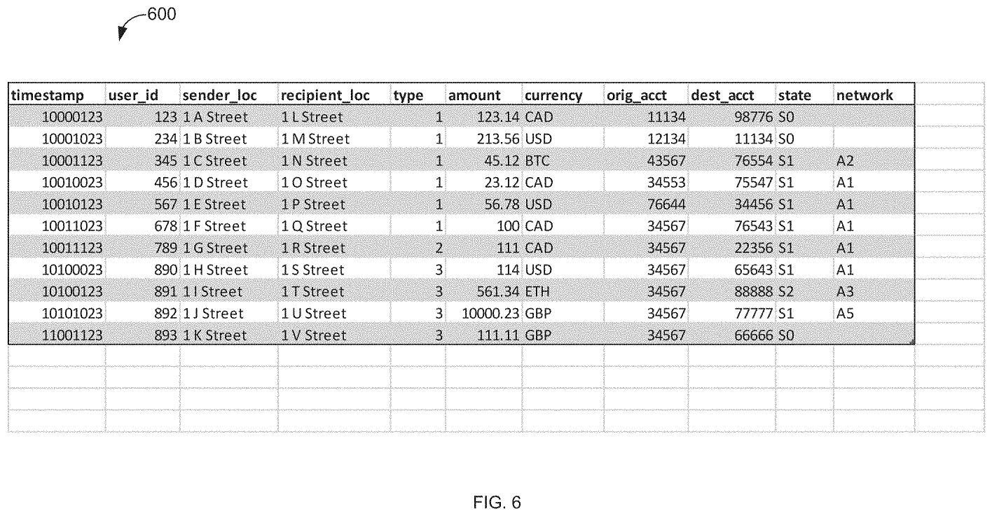

The network controller can send and/or receive various data via the network 104 (FIG. 1A). For example, the network controller 156 can operate to receive data associated with the transaction records, exchange rate records, or compliance records, stored in the transaction database 114, the exchange rate database 112, and the compliance database 110 (FIG. 1A). The data associated with the transaction records will be described in more detail in FIG. 6.

The memory component 152 can include Random Access Memory (RAM) or Read-Only Memory (ROM). The memory component 152 may include one or more database(s) and/or file system(s). For example, memory component 152 may accept data from the processor 154 and may store, for example, the historical transaction records and learning engine, in non-persistent and/or persistent memory. The memory unit may store instructions executable by the processor unit 154.

Memory component 152 may also be used to store an operating system and/or other programs as is commonly known by those skilled in the art. For instance, an operating system provides various basic operational processes for the server 106 to provide a transaction router. Other programs may include various user programs so that a user can interact with the learning engine to perform various functions such as, but not limited to, viewing and manipulating data as well as sending queries and receiving query results as the case may be.

The non-transitory storage 160 can include RAM or ROM, one or more hard drives, one or more flash drives or some other suitable data storage elements such as disk drives, etc. The memory component 152 may include one or more database(s) and/or file system(s) that may be stored on non-transitory storage 160.

Non-transitory storage 160 may also be used to store an operating system and/or other programs as is commonly known by those skilled in the art.

The system bus 162 may connect the memory unit 152, the processor unit 154, the network controller 156, the display controller 158 and the non-transitory storage 160. The system bus 162 may be a PCIe bus. The processor unit 154 may operate to execute instructions stored in the memory unit 152 that define a transaction router.

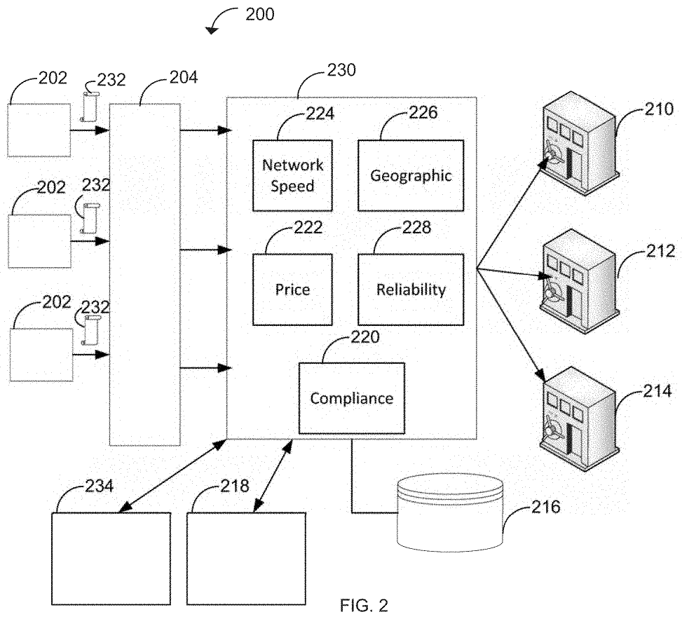

Referring to FIG. 2 there is shown a block diagram of components interacting with a transaction routing system. The transaction routing system 200 may have a learning engine 230, a fraud analysis engine 204, a plurality of transaction producers 202, a plurality of transaction requests 232, a database 216, an exchange rate database 218, a compliance database 234, a first payment network 210, a second payment network 212, and a third payment network 214. For the purposes of illustration three payment networks 210, 212 and 214 are displayed but it will be appreciated that the number may be higher than three. For the purposes of illustration, three transaction producers (or payors) 202 are shown, but it will be appreciated that the number of producers (or payors) may be significantly higher, for instance in the thousands or millions. The exchange rate database 218 may include exchange rate information between currencies, and may be determined based on access to a 3^{rd} party API providing exchange rate information. The compliance database 234 may include compliance information, such as watch lists of payors or payees (either individuals or organizations) that have been identified as high risk by a 3^{rd} party, the compliance information may be determined based on access to a 3^{rd} party API for providing compliance information.

A transaction producer 202 may be a payor. The payor may access a website, mobile application, or the like, to communicate a transaction request 232 to the transaction router 200. Alternatively, the payor may integrate another software application with the transaction router using an API provided by the transaction router. A transaction request 232 may be sent by a payor, and may identify a combination of payor, a payor organization, a unique identifier associated with the payor, a payor organization, a unique identifier associated with the payor organization, a payee, a unique identifier associated with the payee, a payee organization, a unique identifier associated with the payee organization, a payor device id, a payor device type, a payor internet protocol (IP) address, payor geolocation information, payee geolocation information, the purpose of the transaction, the type of transaction, the transaction amount, payor currency information, payee currency information, a payor account number for example, a bank account number or Primary Account Number (PAN), a payee account number for example, a bank account number or Primary Account Number (PAN), payor contact information (for instance, mailing address, telephone number), payee contact information (for instance, mailing address, telephone number), and a payor risk level. The transaction request 232 may be received and processed by the fraud analysis engine 204. Having passed the fraud analysis engine 204, the transaction request may proceed to the transaction routing learning engine 230.

The transaction router learning engine 230 may have transaction requests 232 having several different components including a network speed 224, a geography 226, a price 222, a reliability 228, a compliance 220 (also referred to as a compliance level), and may further include payment instrument data (not shown). It will be appreciated that the transactions of the learning engine may have only one component, a subset of components, or the set of components shown in FIG. 2.

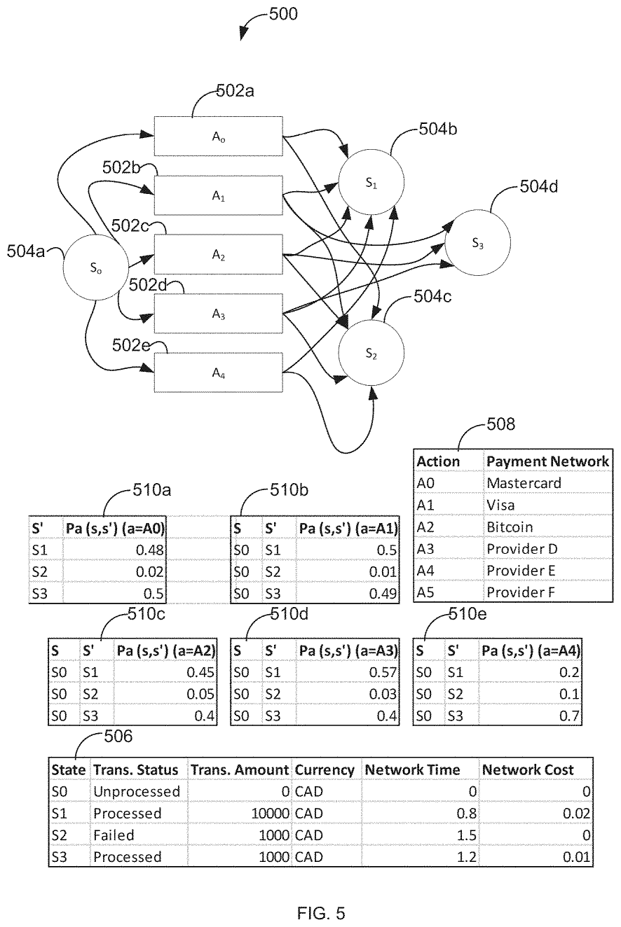

The transaction routing engine 230 may setup (or model) the transaction processing system as an MDP problem, and may implement a reinforcement learning solution to determine which actions (or payment networks) provide a desired benefit. The routing engine may therefore determine a routing of a transaction to a particular payment network based on historical transaction data and further based on the transaction request components. The transaction routing engine 230 may further implement an adaptive control model. The transaction routing engine 230 may further implement a Markov Decision Process, as described in further detail in FIG. 5.

The machine learning engine may have a plurality of states, a plurality of actions. For each action, there may exist a probability distribution representing the likelihood that an action taken for a transaction in a particular first state will lead to a transaction in a second state. The machine learning engine may have a state transition table for each transition that includes a plurality of state transition probabilities corresponding to the probability distribution. Furthermore, the machine-learning engine may have a reward function that, for a given action from a first state to a second state, may assign an reward for arriving at the second state.

Alternatively, some aspects of transaction routing may be based on components that are rule based (for instance, whether a particular action or payment network can transact money with a particular country). In such a rule-based case, the probability distribution in the state transition table may be pre-determined based on the rule set. In one example, the action that transitions a transaction from a first state to a second state representing an unsupported country may be assigned a probability of 0. The geographical coverage of a payment network may therefore be pre-determined by an operator of the transaction router. In such a situation, the reward function may be predetermined as well.

The database 216 may contain historical transaction data and external compliance resources that may include resources and watch lists. The external compliance resources may be provided by a 3^{rd} party, for instance through the use of an 3^{rd} party API.

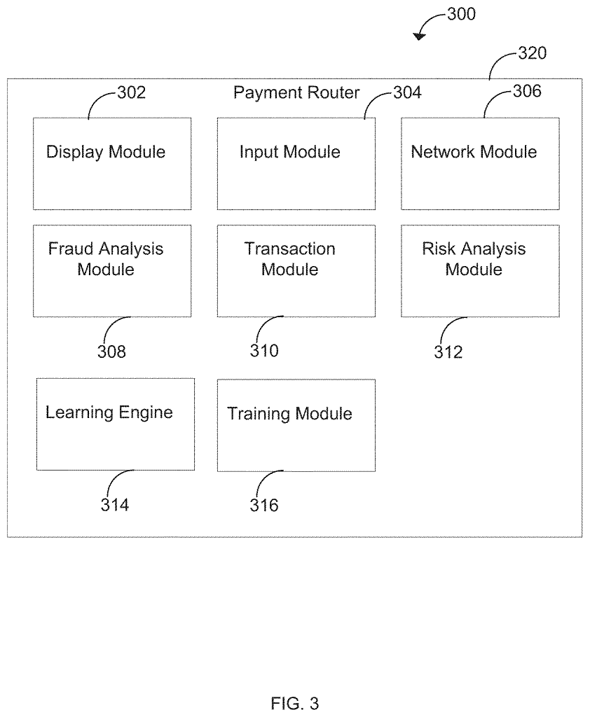

Referring to FIG. 3, there is shown a software component diagram 300 of the transaction router. The transaction router (also referred to herein as the transaction router) 320 has a display module 302, an input module 304, a network module 306, a fraud analysis module 308, a transaction module 310, a risk analysis module 312, a learning engine 314, and a training module 316.

The display module 302 may provide a user interface for the transaction router that may operate to provide an interface for users to submit transaction requests. This user interface may be provided to a user via a mobile application or a web application available over the network. The display module may further provide operational statistics about the transaction router to administrative users and allow them to make configuration changes to the transaction router.

The input module 304 may accept input in the form of user input, or transaction requests sent from the user interface. The input module may be an API that accepts transaction requests from users or organizations. In such a scenario, the interaction with the API may enable a machine to machine integration such that another software application may use the transaction router as a payment gateway. The input module may authenticate users and provide interfaces to user accounts remotely to users.

The network module 306 may provide the transaction router with secure transmission of transaction requests and transactions to payment networks. The network module may provide encryption to connections between the transaction router and its users, and the transaction router and the plurality of payment networks, for example the network module may provide Secure Sockets Layer (SSL) or Transport Layer Security (TLS) encrypted communications between the server 106 (see FIG. 1) and the databases 114, 112, 110 on a database server, between the server 106 and the plurality of client system 116 and 102 (FIG. 1), or between the server 106 and any other service.

The fraud analysis module 308 may operate to identify and flag fraudulent transactions as they are received by the transaction router. A transaction that passes the fraud analysis performed by the fraud analysis module may then be routed by the learning engine 316.

The transaction module 310 may respond to a transaction request received from a payor to create a transaction that may be routed based on the learning engine 314. Particular fields of the transaction may correspond to fields received by the transaction request. The transaction module 310 may record a record of the transaction into an independent transaction log. Furthermore, the transaction module 310 may operate to determine operational statistics about historical transactional data, or to record a transaction in the historical transaction data once the transaction is complete.

The risk analysis module 312 may operate in parallel with the fraud analysis module 308 to determine the potential risk of a transaction request and flag potentially risky transactions. Risk may include determining the risk of a criminal transaction, such as money laundering.

The learning engine 314 may setup the transaction routing problem as an MDP, and may implement a machine learning algorithm such as reinforcement learning that may make routing decisions based on the identified components in the MDP model. The machine learning algorithm may be a supervised learning system, where a user evaluates a particular transaction to provide feedback to the learning system, or it may be an unsupervised learning system. The learning engine may make routing decisions based upon a plurality of components, where each component itself may receive feedback for each completed transaction so that the probability distribution and reward function may be updated as the system continues to route transactions.

The generation of the probability distribution may be referred to as the MDP model (or problem) generation, and may be determined from historical transaction data by the training module 316. The reward function(s) may be defined by an operator and may include a weighted linear combination of the individual state components. The training module 316 may use the set of historical transactions, as well as other available information (for instance, exchange rate information from a 3^{rd} party API as described herein) to determine a solution to the MDP problem, for instance by creating a reinforcement learning solution where an agent acts on its state (environment) and it receives an evaluation of the available actions (reinforcement or reward). The processing of a transaction can be modelled as an MDP in order to derive the probability distributions for state transitions given actions taken historically. The modelling of the MDP to determine the probability distributions may be performed periodically by the training module 316 or may be performed each time a transaction is processed.

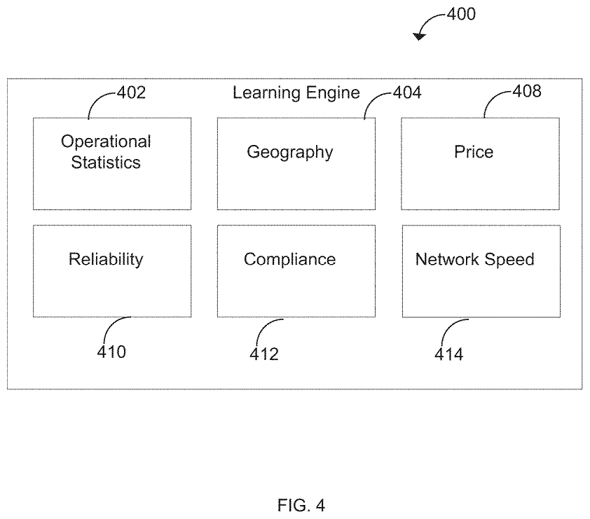

Referring to FIG. 4, a software component diagram 400 of a transaction routing learning engine, having operational statistics 402, a geography component 404, a price component 408, a reliability component 410, a compliance component 412, and a network speed component 414. It will be appreciated that the learning engine may have one of, a subset of, or all of the components shown. Operational statistics 402 may provide an administrator with information about the operational environment of the learning engine such that it may be monitored, and the learning engine may be used in the discretization process described below.

The network speed component 414 may operate to determine the network speed for the plurality of processed states. This may involve an analysis of the historical transactions in each state, including an average, mean, or median value of network speed. The network speed component may be further operable to create or update the particular network speed reward component in real-time as transactions are processed, or in batch at regular intervals.

The geographic component 404 may operate to determine the geography for the plurality of processed states. This may involve querying a table in the database corresponding to the available countries for each payment network. The geographic component may be updated periodically with new locations available for a given payment network as they become available.

The price component 408 may operate to determine the price for the plurality of processed states. This may involve an analysis of the historical transactions in each state, including an average, mean, or median value of price. The price component may be further operable to create or update the particular price reward component in real-time as transactions are processed, or in batch at regular intervals.

The reliability component 410 may operate to determine the reliability for the plurality of processed states. This may involve an analysis of the historical transactions in each state, including an average, mean, or median value of reliability. The reliability component may be further operable to create or update the particular reliability reward component in real-time as transactions are processed, or in batch at regular intervals.

The compliance component 412 may operate to determine the compliance for the plurality of processed states. This may involve querying a table in the database corresponding to a predetermined compliance value for each payment network.

Referring to FIG. 5, a state diagram 500 of a Markov Decision Process is illustrated. The state diagram shows a plurality of states S₀ 504a, S₁ 504b, S₂ 504c, S₃ 504d and a plurality of actions A₀ 502a, A₁ 502b, A₂ 502c, A₃ 502d, and A₄ 502e describing a set of state transitions (as indicated by the arrows). State diagram 500 also shows a state table 506, an action table 508, and state transition probabilities 510a, 510b, 510c, 510d, 510e, and 510f.

States may be referred to as a vector based representation based on the state tuple {state, transaction status, transaction amount, currency, network time, network cost}. The individual elements of the tuple may be referred to as state components. The currency state component may be, for example, the Canadian Dollar (CAD), the Pound Sterling (GBP), the United States Dollar (USD), etc. The set of all states may be referred to as a state space. It will be appreciated that the state tuples shown in the state table 506 may have other elements that are not shown that are based upon other transaction request data or transaction data, or other data related to the transaction router. The state space diagram 500 is shown in a two dimension visual representation in FIG. 5 for illustrative purposes. It will be appreciated however that the state space is n-dimensional (i.e. the state space has a plurality of dimensions), each dimension generally corresponding to an element or component of the state tuple. State S₀ 504a represents the tuple {S₀, unprocessed, 0, CAD, 0, 0}, and is the state where new transactions begin when a transaction request is received. State S₁ 504b represents the tuple {S₁, processed, 10000, CAD, 0.8, 0.02}. State S₂ 504c represents the tuple {S₂, failed, 1000, CAD, 1.5, 0}. State S₃ 504d represents the tuple {S₃, processed, 1000, CAD, 1.2, 0.01}. These tuples correspond to state table 506, and it will be appreciated that there may be a plurality of states, and many more than shown. Since transaction time and transaction price are continuous, we must discretize the quantities into “buckets”.

The operational statistics module 402 (see FIG. 4) may discretize the state space to break it into chunks. Such a discretization may represent states as “buckets” where transactions contained within the bounds of a bucket are considered to be in that bucket. For instance, S₁ may include transactions having a network time of plus or minus 0.05. Similarly, S3 may include transactions having a network cost of plus or minus 0.005. This range or interval or interval distance may be configurable per element or dimension of a state tuple and may represent a tradeoff between prediction accuracy and computational requirements. The learning engine and the administrator of the transaction router may use discretization to determine the distribution of components of a state space into representative “buckets”.

There may be other dimensions beyond those shown in FIG. 5. Any of the transaction data or transaction metadata may function as a dimension of state. For example, other dimensions may include time of day, transaction amount, day of week, day of year, week of year, etc. In cases where the state space includes other dimensions, the state tuples will similarly include this information.

Action A₀ 502a is an action that transitions a transaction from S₀ to S₁ or S₂ using the Mastercard® network according to the state transition probability 510a. Action A₁ 502b is an action that transitions a transaction from S₀ to S₁ or S₂ using the VISA® network according to the state transition probability 510b. Similarly, Action A₁ 502b may transition a transaction from S₀ to S₃ depending on circumstances. Action A₂ 502c is an action that transitions a transaction from S₀ to S₁ and S₂ using a blockchain based network such as Bitcoin according to the state transition probability 510c. Similarly, Action A₂ 502c may transition a transaction from S₀ to S₃ depending on circumstances. A₃ 502d is an action that transitions a transaction from S₀ to S₁ or S₂ using payment network Provider D′ according to the state transition probabilities 510d. Similarly, Action A₃ 502b may transition a transaction from S₀ to S₃ depending on circumstances. A₄ 502e is an action that transitions a transaction from S₀ to S₁ or S₂ using payment network Provider E′ according to the state transition probability 510e. It will be appreciated that while only 5 actions are displayed in this diagram, that there may be many more actions available depending on the available payment networks, as each action corresponds to a given payment network.

Actions may each transition transactions to a plurality of states depending on the particular response data from the payment network. For example, a plurality of states may represent transactions falling into different buckets based on network time (the length of time to perform the transaction by the payment network), or network cost (the amount of money paid to the payment network to perform the transaction). This allows continuous variables such as network time or network cost to be grouped into states according to transaction data, transaction metadata, transaction request data, or transaction request metadata.

Actions may be described in an action table such as the one shown at 508. The action table may be stored in a database and may include additional fields beyond those shown at 508.

State transition table 510a may be determined from historical transactions, and may generally describe the probability of a transaction transitioning from an initial state S to a next state S′ given an action a (A₀ as shown at 510a). At 510a, state transition table shows that for a transaction in an initial state S₀, taking the action A₀ results in a 48% chance of transitioning into state S₁, a 2% chance of transitioning into state S₂, and a 50% chance of transitioning into S₃.

State transition table 510b is shown for action A₁. State transition table 510c is shown for action A₂. State transition table 510d is shown for action A₃. State transition table 510e is shown for action A₄.

In the present example, initial state may be S₀. There may be, however, multiple initial states S₀ᵢ₋₀₁ such that multiple initial states operate multiple actions that transition the transactions into a plurality of output states.

The state transition tables in FIG. 5 may be determined by determining a plurality of probability distributions corresponding to the plurality of state transitions in the set of historical transactions. The state transition tables may be determined, for example, by determining a set of states (optionally, this may include removing irrelevant states, such as states with a number of transactions below a particular threshold), determining the historical transactions in each state, and for each action, determining a state transition table. The state transition table may include a plurality of state transition entries from an initial state S to a next state S′, each entry having an associated transition probability calculated from the number of transactions in the given next state S′ divided by the total number of transactions transitioned using the given action.

These states, actions, state transition tables, and a reward function when taken together describe a Markov Decision Process and solving the problem defined by the MDP using reinforcement learning determines the optimal routing decision for a transaction. The routing decision (may also be referred to as the policy, or Tr) forming the solution to the MDP determines the correct action corresponding to a payment network to route the transaction to in a manner that achieves the highest potential reward (based on the reward function). The benefit may be derived from user preferences, a reward function, a transaction state, and the state transition tables from the initial state into a plurality of next states. Processing the transaction using a particular payment network may reinforce the solution to the MDP based on the outcome of the transaction. For instance, the user may prefer to have a low cost, a faster processing time, or a combination of both low cost and fast processing time. The user preferences may affect the reward function.

The routing decision π may be made based on the function:

π:=argmaxₐ{Σₛ,Pₐ(s,s′)(Rₐ(s,s′)+γVₐ(s′))} (equation 1)

In equation 1, the routing decision (Tr) or policy is the action that provides the maximum expected action score. The individual particular action scores for each action (payment network) are evaluated and then the maximum is selected as the routing decision (policy). A particular action score may be calculated as the summation of the product of the probability of a transition Pₐ(s, s′) and the reward of the transition from s to s′Rₐ(s, s′) plus the discounted future action score γV(s′). The expected action score of each action may be calculated and then the action having the highest expected value may be selected as the policy or routing decision (π).

Rₐ(s,s′)=wₛn+wₚp+wᵣr+w_{g}g+w_{c}c (equation 2)

Equation 2 is the reward function for a transition from state s to state s′. Where wₛ is the network speed weighting assigned by a user, s is the network speed reward component, p is the price reward component, r is the reliability reward component, g is the geographic reward component, c is the compliance reward component, wₚ is the price weighting assigned by a user, wᵣ is the reliability weighting assigned by a user, w_{g} is geographic weighting, and w_{c} is the compliance weighting. The geographic weight w_{g} may be selected based on a predetermined rule based on the geographic location of the intended recipient and the support geography of a particular payment network. The compliance weight w_{c} may be selected by a user, or predetermined based on a known value associated with the particular payment network. The reward for arriving at a given state s′ by action a may be driven by user preferences, and may be determined by a linear combination of the weights assigned by a user in preferences and the predicted reward for each component including network speed, price, geographic reach, and compliance. Other components may be used to determine the reward Rₐ, and may be based on other transaction data or other transaction metadata. The reward function Rₐ(s, s′) in equation 2 may be referred to as a weighted linear combination of state components, but may instead be an exponential, logarithm, trigonometric function, or a itself may be a probability function. The reward components n, p, r, g, and c may all be determined from dimensions of the next state s′, and may be determined using at least one reward component function. The reward component functions may be predetermined by the transaction router administrator, and may provide a scalar reward component value based on the particular component value for a particular state.

V(s′) contains the average discounted sum of future rewards to be earned from state s′ to a final state, and is defined recursively in equation 3:

V(s):=Σₛ,P_{π(s)}(s,s′)(R_{π}(s,s′)+γV(s′)) (equation 3)

For the purposes of the Markov Decision Process shown in FIG. 5, the discounting factor γ is taken to be 0, since there is only one action to be taken to transition a transaction from processed to unprocessed status. However, in other cases the Markov Decision Process may include more than one intermediary step between the unprocessed and processed transaction statuses. For example, a payor's transaction request to send CAD $100 to a payee located in England (who prefers receipt of fund in GBP), and the payor's preference to perform the transaction for the lowest cost possible may result in the transaction processing from CAD to USD first, and then from USD to GBP if the reward of converting CAD-USD-GBP is higher than of CAD-GBP. In the case that there is more than one intermediary step between the processed and unprocessed states, the discounting factor γ may be non-zero, and equation 1 and equation 3 may be used recursively or iteratively to determine a policy.

Once a routing decision is made by the transaction router, response data from the payment network may update the transaction, including updating the database. This may result in, for example, the transaction status being updated to “processed”, the transaction time being set to the elapsed time taken by the payment network, and the transaction price being set to the price paid to the payment network to process the transaction.

In this way, the transaction router may operate to predict the likelihood of a transaction in an initial state s arriving in a particular next state s′, determine a routing decision for the transaction given the transaction data and the transaction metadata based upon a reward function that may incorporate user preferences.

Referring to FIG. 6, there is illustrated a transaction table 600 showing exemplary data relating to transactions. The transaction table 600 may be a table in the database 114 (see FIG. 1), and it may contain a set of historical transactions of the transaction router. Each transaction may have a plurality of timestamps (indicating the time of creation, time of update, time of transaction, etc.), a user id representing a unique user identifier, geolocation information of the payor/sender, geolocation of the payee/recipient, a transaction type, a transaction amount, at least one transaction currency (there may be more than one currency involved), an originating account unique identifier, a destination account unique identifier, a transaction state, and the network used to process the transaction (also referred to herein as the action taken). The transaction may further comprise of the following fields: company or organizational identifier, payor address information, payee address information, transaction purpose, payment network price (i.e. the amount of money paid to process the transaction on the particular payment network), and a payor acceptable risk level. The transactions in the transaction table may correspond to transaction requests submitted by users.

The historical transactions in FIG. 6 may also be used by, for example, the operational statistics module 402 (FIG. 4) to provide metrics and analytical information based on the historical transaction information. This may include operational statistics about each payment network including pricing, error rates for transactions (i.e. the percentage of transactions in state S₂), volume of transactions, network speed, etc.

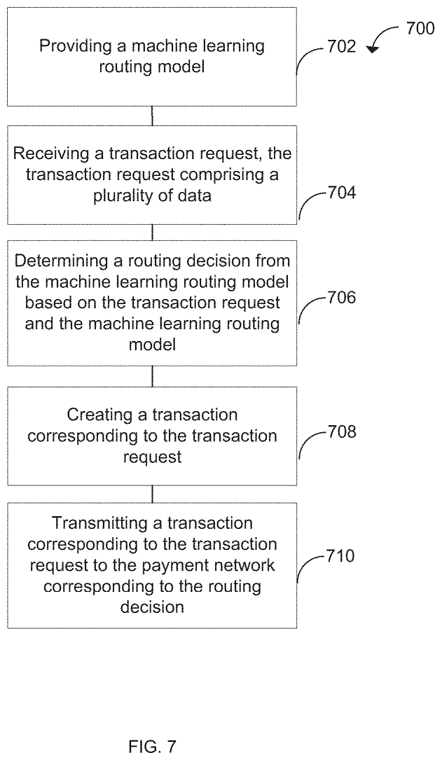

Referring to FIG. 7, a flowchart 700 is illustrated showing a method of transaction request routing. The method 700 may run on the processor 154 (FIG. 1B) of server 106 (FIG. 1A).

At 702, a machine learning routing model is provided. The routing model may comprise a plurality of states, a plurality of actions defined by the available payment networks, a plurality of state transition tables, and a plurality of associated reward functions describing each transition from s to s′ along an action a in terms of user defined weightings. The plurality of state transition tables corresponding to the plurality of actions, each state transition table defining a plurality of state transition entries, each state transition entry defining an initial state s, a next state s′, and a probability associated with the transition from s to s′ using the action. The provision of the routing model may depend on the execution of a training task that accepts historical transaction data as input.

At 704, a transaction request is received comprising a plurality of data. The transaction request data may correspond to the data used in the transaction that is sent to the payment network when a routing decision is made. The transaction request may be sent from a user on a mobile application or via a website. The transaction request may further originate programmatically through an API. The transaction request may further include an association with the payor users preferred reward weights, and the payee users preferred reward weightings if either exist. If either the payor or the payee does not have a preferred transaction routing reward weighting, default values for the weightings may be used. If the payor or the payee does have a preferred transaction routing reward weighting, for example if they prefer to use a payment network with a high degree of compliance to industry standard security, such a preference may be included in the weightings and such a preference may result in VISA® or MASTERCARD® networks processing the transaction instead of the transaction being sent using a blockchain based network such as the Bitcoin network (the Bitcoin network having less compliance to said industry standard security than the VISA® or MASTERCARD® networks).

At 706, a routing decision (Tr) is determined from the machine learning routing model, the users (payor and/or payee) preferences and the transaction request. The routing decision (π) may be determined from the plurality of actions available at the initial state S₀. For each action, a summation (the action score) of the product of the probability of each state transition Pₐ(s, s′) and the associated reward Rₐ(s, s′) for the transition is performed as described above. This determination represents the solution to the MDP model, and may be solved once per transaction, or may be solved periodically. The routing decision may reflect the action providing the maximum overall action score. Similarly, the MDP problem model may be solved by policy iteration or value iteration where all possible transitions are explored. Generally speaking, reinforcement learning may be used to solve the MDP where the state space is large and policy iteration or value iteration would be require significant computation.

At 708, the transaction router may create a transaction record in the database corresponding to the transaction request.

At 710, the transaction corresponding to the transaction request is transmitted to the determined payment network and a transaction response is received. The transmitting of the transaction may be to a third party payment network in network communication over the network 104 (see FIG. 1A). The transaction response from the payment network may be used to update the transaction record in the historical transaction database and may update the machine learning routing model such that the transaction (including the data corresponding to the transaction request) and its response may change the state space.

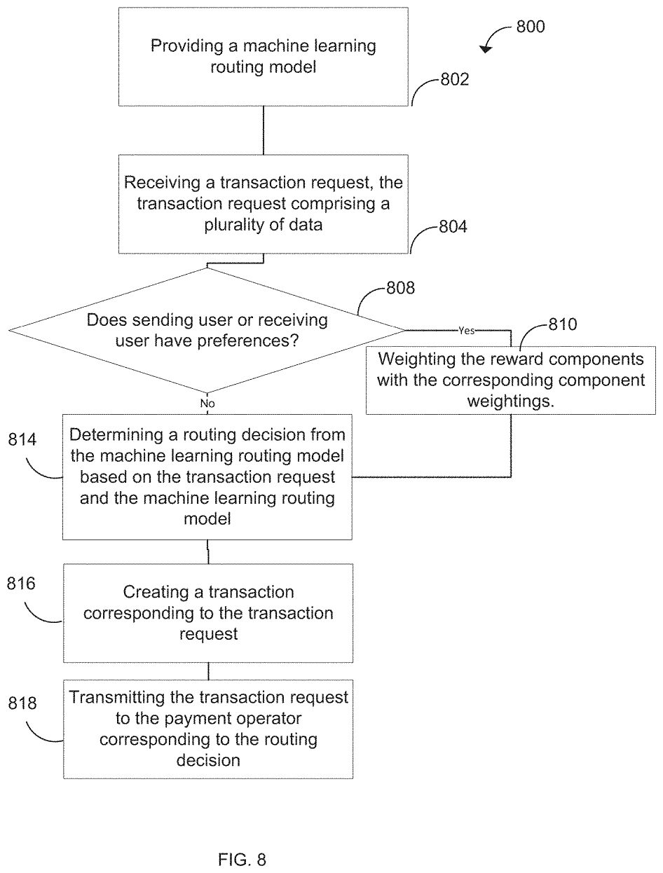

Referring to FIG. 8, a flowchart 800 is illustrated showing another method of routing payment transfers (or transactions) using a transaction router. The method 800 may run on the processor 154 (FIG. 1B) or server 106 (FIG. 1A).

At 802, a machine learning routing model is provided. The routing model may comprise a plurality of states, a plurality of actions defined by a available payment networks, a plurality of state transition tables, and a plurality of associated reward functions describing each transition from s to s′ along an action a in terms of user defined weightings. The plurality of state transition tables corresponding to the plurality of actions, each state transition table defining a plurality of state transition entries, each state transition entry defining an initial state s, a next state s′, and a probability associated with the transition from s to s′ using the action. The provision of the routing model may depend on the execution of a training task that accepts historical transaction data as input.

At 804, a transaction request is received comprising a plurality of data. The transaction request data may correspond to the data used in the transaction that is sent to the payment network when a routing decision is made. The transaction request may be sent from a user on a mobile application or via a website. The transaction request may further originate programmatically through an API. The transaction request may further include an association with the payor users preferred reward weights, and the payee users preferred reward weightings if either exist. If either the payor or the payee does not have a preferred transaction routing reward weighting a default value may be used. If either the payor or the payee have a preferred transaction routing reward weighting, for example, if they prefer to use a payment network with a high degree of compliance to industry standard security, such a preference may be included in the weightings and such a preference may result in VISA® or MASTERCARD® networks processing the transaction instead of the transaction being sent using a blockchain based network such as the Bitcoin network.

At 808, the method may determine if the payor user or payee user has configured preferences with respect to their desired parameters for transaction routing. The parameters may include scalar numbers for: wₛ, the network speed weighting, wₚ the price weighting, wᵣ is the reliability weighting, w_{g} is a geographic weighting, and w_{c} is a compliance weighting. For example, if the user prioritizes price higher than network speed, the wₚ may be higher than wₛ. If the user has not set preferred weightings, a default set may be used and the method may proceed as in FIG. 7.

If the user has configured preferences with respect to their desired parameters, at 810, the predicted reward values of the actions that may transition a transaction from unprocessed to processed status may be determined from the machine learning routing model. For each action, the state transition table may be used to determine the probability of transitioning from the initial unprocessed state of the transaction (generally this is S₀) to a next state processed state. For example, in FIG. 5, the state transition tables 510a, 510b, 510c, 510d, 510e are shown, and each row in the state transition tables may represent a single probability of transition from a first state to a second state. The reward of each state transition Rₐ(s, s′) for the action is determined using equation 2.

At 814, a routing decision (π) may be determined following equations 1, 2 and 3 above. For each action available to transition the transaction from processed to unprocessed, the summation of the product of the probability of each transition s to s′ Pₐ(s, s′) and reward for the transition Rₐ(s, s′) is determined (referred to as the expected action score). The routing decision (π) is selected based on the action having the maximum expected action score.

At 816, with the routing decision determined, a transaction corresponding to the transaction request is created in the database in an unprocessed state.

At 818, the transaction corresponding to the transaction request is transmitted to the determined payment network and a transaction response is received. The transaction response from the payment network may be used to update the transaction record in the historical transaction database and may update the machine learning routing model such that the transaction (including the data corresponding to the transaction request) and its response may change the state space. The transaction record in the historical transaction database may be subsequently used to train the machine learning routing model such that the transaction (including the data corresponding to the transaction request) and its response may change the probability distributions of state transitions.

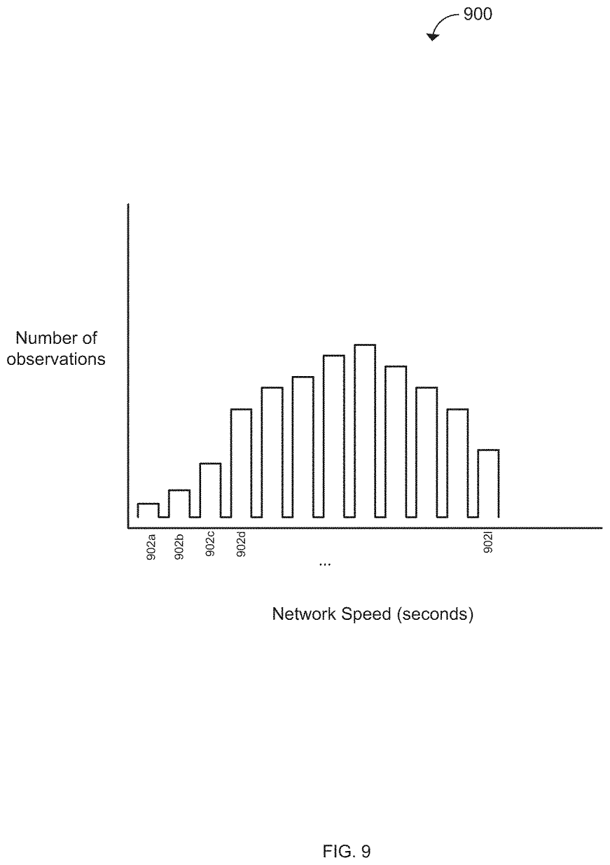

Referring to FIG. 9, where there is illustrated representative operational statistics of various aspects of network speed metrics for the historical transaction data of a particular payment network. FIGS. 9, 11, 12 may be used in an operational sense to assist an administrator in developing a discretization of the state space based on the observed data from historical transactions. The example operational statistics include a probability distribution of network speed (in seconds) at 900. The operational statistics drawing in 900 may be determined from the historical transaction data by the operational statistics component (402 in FIG. 4). The network speed of a payment network may be dependent on other factors such as the time of day, the transaction amount, and the geographical destination. The operational statistics in FIG. 9 may assist in developing a discretization model of the network speed dimension. These factors may influence the probability distribution of the network speed factor.

As shown at 900, the number of observations may generally follow a normal distribution. Representative of this trend in data, the plurality of states may include a network speed dimension whose distribution is dependent on time of day. This dimension may have a plurality of buckets 902a, 902b, 902c to 9021 based on a specified bucket size (or interval length). For example, each bucket may represent a tenth of a second. The interval length or bucket size may be configurable based upon an administrator's preference.

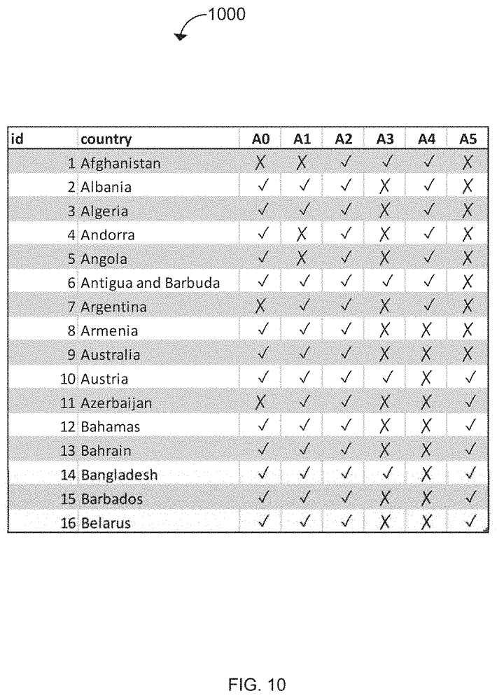

Referring to FIG. 10, which illustrates supported geographic destinations (shown as rows) 1000 of the plurality of payment networks A₀, A₁, A₂, A₃, A₄, and A₅. (shown as columns) representing the actions in the transaction router. The example supported destinations 1000 are shown as binary supported/unsupported value. The supported destinations may be represented as a geographic dimension of payee (or recipient) geographic location, or simply of payee (or recipient) address. These binary supported, unsupported values may be represented as a geographic dimension in the state space wherein the state entries define transitions having 0% probability. In such a way, the transaction router may devalue and eliminate routing decisions where the action taken to transition from s to s′ results in an invalid scenario where the destination country of the transaction is unsupported by the payment network since the expected action score would be zero since all probabilities would be zero.

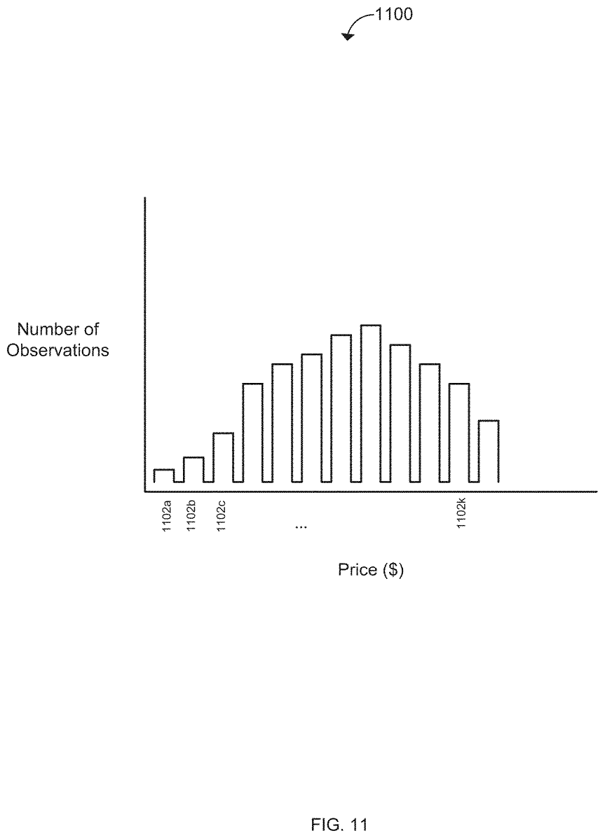

Referring to FIG. 11, where there is illustrated representative operational statistics of various aspects of price metrics for the historical transaction data of a particular payment network. The example operational statistics include a probability distribution of the number of observations versus price at 1100. The operational statistics drawings in 1100 may be determined from the historical transaction data by the operational statistics component (402 in FIG. 4).

The price of a payment network may be dependent on factors such as the time of day, the transaction amount, and the transaction metadata volume of transactions. These factors may influence the probability distribution of the price value.

As shown at 1100, the price may generally follow a normal distribution, reflecting the fact that payment networks may charge a variable amount based around an average. Representative of this trend in data, the plurality of states may include a price dimension based upon the time of day. This dimension may have a plurality of buckets 1102a, 1102b, 1102c to 1102k based on a specified bucket size (or interval length). For example, each bucket may represent ten cents, or alternatively, one dollar. The interval length or bucket size may be configurable based upon an administrator's preference.

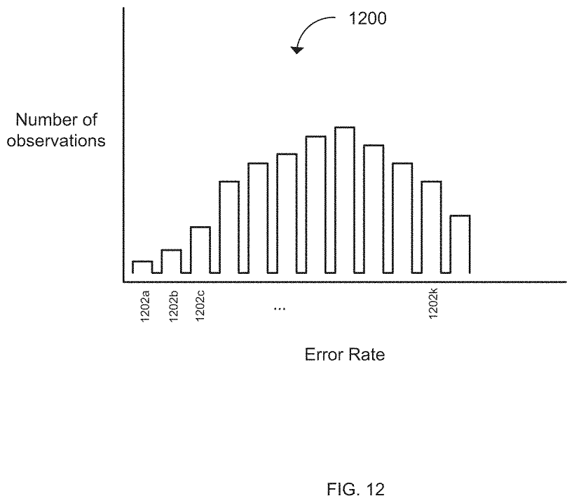

Referring to FIG. 12, where there is illustrated representative operational statistics of various aspects of reliability metrics (or in inverse form, error rate metrics) for the historical transaction data of a particular payment network. The example operational statistics include a probability distribution of number of observations versus error rate at 1200. Error rate (also referred to herein as the inverse reliability) may represent a reliability dimension based on transaction response data from a particular payment network. This may reflect the fact that some payment networks are unreliable during particular parts of the day when volume is higher. The operational statistics data in 1200=may be determined from the historical transaction data by the operational statistics component (402 in FIG. 4).

The reliability of a payment network may have several hidden dimensions based on factors such as the time of day or based on a moving window. The reliability may change throughout the day, and may be higher during higher volume periods. Similarly, in the case where a payment network has an outage, the outage may be determined based on a historical moving window.

As shown at 1200, the error rate may generally follow a normal distribution, reflecting the fact that payment networks may typically provide a particular service level. Representative of this trend in data, the plurality of states may include an error rate (or by inverse, the reliability) based upon the time of day. This dimension may have a plurality of buckets 1202a, 1202b, 1202c to 1202k based on a specified bucket size (or interval length). For example, each bucket may represent one hour, or alternatively, each bucket may represent one minute. The interval length or bucket size may be configurable based upon an administrator's preference. The error rate may be given as a percentage, for example, 0.5%.

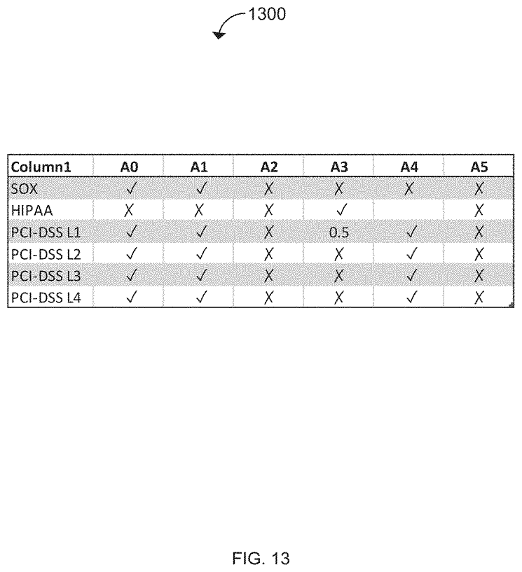

Referring to FIG. 13, which illustrates supported compliance metrics (shown in rows) 1300 of the plurality of payment networks A₀, A₁, A₂, A₃, A₄, and A₅ (shown in columns) representing the actions in the transaction router. The example supported destinations 1300 are shown as binary supported/unsupported value. The supported compliance metrics may be represented as a compliance dimension of the payment network's compliance (or predicted compliance) with a set of security standards, legal standards, privacy standards or the like. The standards may include Sarbanes-Oxley (SOx), Health Insurance Portability and Accountability Act (HIPAA), or the different levels of compliance with the Processing Card Industry Data Security Standard (PCI DSS). These binary supported, unsupported values may be represented as a dimension in the state space wherein the state entries define transitions having 100% and 0% probability respectively. Alternatively, the transaction router may have a non-zero compliance probability where the transaction router operator determines that a particular payment network should be treated as somewhat compliant. For example, payment network A₃ may have an assigned compliance rating of 50% for PCI-DSS L1. In such a way, the transaction router may devalue and eliminate routing decisions where the action taken to transition from s to s′ results in a scenario where a transaction is processed using a non-compliant network.

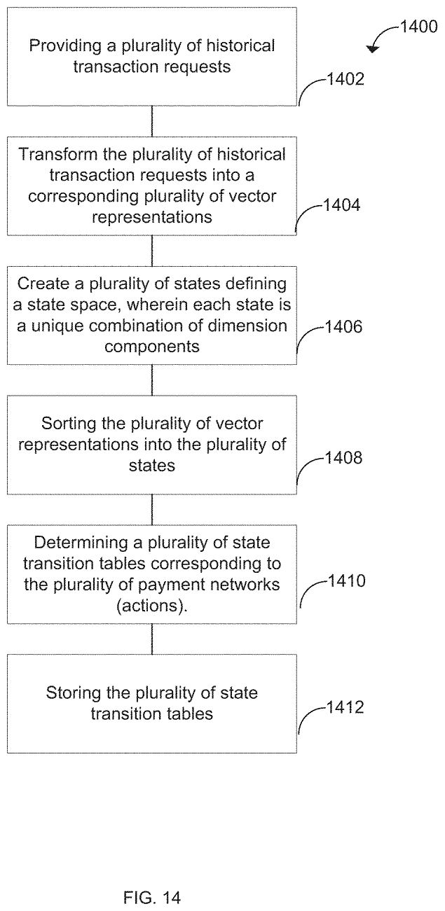

Referring to FIG. 14, a flowchart drawing 1400 is shown describing the method of creating an MDP model in accordance with at least one embodiment. The MDP model may describe the problem that the reinforcement learning system in the form of the transaction router may solve using a machine learning routing model. The MDP model may comprise a plurality of actions corresponding to a plurality of payment networks, a plurality of states, a plurality of state transition tables, a reward function, and optionally a discounting factor γ. Any of the method described in 1400 may operate either sequentially or in parallel. The method in FIG. 14 may be a training function, and may operate to create the data for the decision making of the transaction router. The method of FIG. 14 may run on the processor of the server found in FIG. 1A. The method in FIG. 14 may be used to generate the solution to the MDP, using reinforcement learning, policy iteration or value iteration as disclosed herein.

At 1402, a plurality of historical transactions is provided that may correspond to the historical transactions performed by the transaction router.

At 1404, the plurality of historical transactions may be transformed into a corresponding plurality of vector representations referred to as tuples that correspond to the structure of the state space. The tuples may be n-dimensional. For example, referring back to FIG. 6, the first transaction found therein may be described in vector form as {10000123, 123, “1 A Street”, “1 L Street”,1,123.14, CAD, 11134, 98776, S₀, A₀}. Components of vector or tuples may be null, or have a zero value.

At 1406, a plurality of states is created, collectively referred to as a state space. The combination of component values for each state is unique for each state such that a single combination of dimension values for a particular state does not exist anywhere else in the state space. As discussed above, the transaction router operator may pre-determine interval lengths for each dimension in the state space such that each state may represent a range of values demarcated by a particular interval length. This determination of interval lengths may be determined via discretization. Optionally, the transaction router system may reduce the size of the state space by combining a subset of states that are functionally equivalent and removing other states that have a 0 percent probability of transition.

At 1408, the plurality of vector representations is sorted into the plurality of states, and once sorted may be referred to as a sorted plurality of vector representations. A vector representation of a transaction will be sorted into a state if and only if each of the components of the vector falls within the interval lengths of the dimension value of the state. Each vector representation is sorted into one state, and each state can be associated with more than one vector representation.

At 1410, a plurality of state transition tables corresponding to the plurality of payment networks (or actions) is determined by the transaction router. The state transition tables correspond to a plurality of state transition entries. Each state transition entry corresponds to a probability of a transaction in an initial state s transitioning into a new state s′ given the particular action a. As shown in FIG. 5, where state transition tables 510a, 510b, 510c, 510d, 510e for actions A₀ 502a, A₁ 502b, A₂ 502c, A₃ 502d, and A₄ 502e respectively are shown. Each state transition table includes a plurality of state transition entries, each entry corresponding to a single transition from a first state s to a next state s′ and its associated probability.

At 1412, the plurality of state transition tables are stored in the database and may be used to make routing decisions as described in FIGS. 7 and 8.

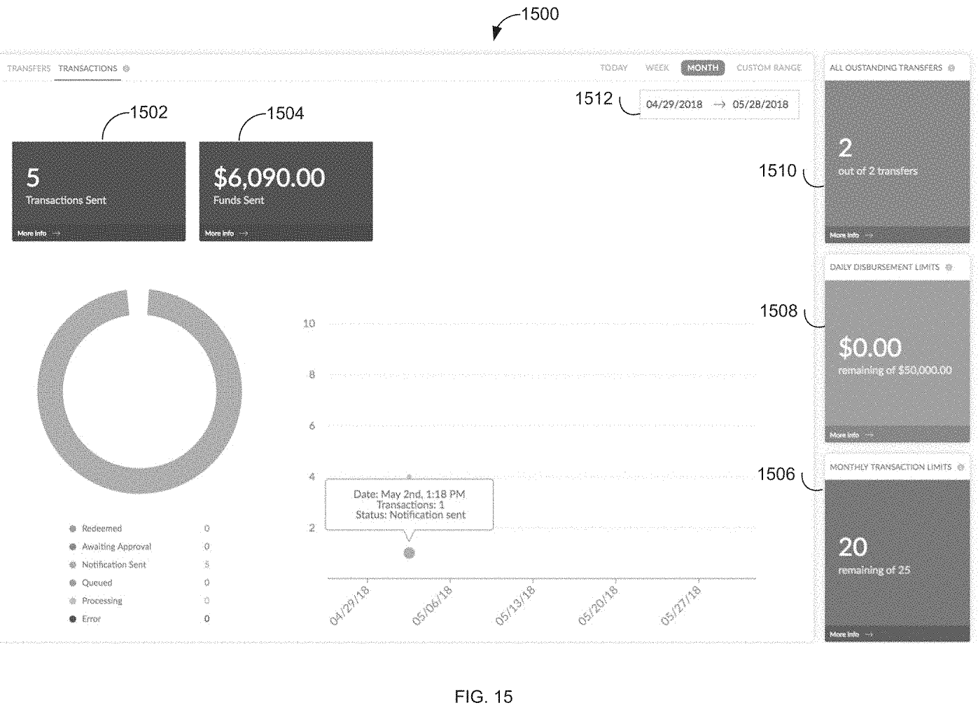

Referring to FIG. 15, which illustrates a screenshot of a dashboard interface 1500. A user may access a web based application running on the server 106 (see FIG. 1), or may connect via a mobile application on a mobile device 116 (see FIG. 1). A payor user may be presented with a dashboard such as the one in FIG. 15 upon authenticating with user credentials such as a login name and password. The dashboard 1500 may include statistics about the particular users operation of the transaction router, including showing the number of transactions sent 1502, the sum of all funds sent 1504, the number of outstanding transfers 1512, the users daily disbursement limit 1508, and the users monthly transaction limit 1506. The dashboard may provide a summary of the user's personal transaction history, or the use of the transaction router via an API in the case where there is an integration with another software application.

The data on the dashboard may be generated on demand by the operational statistics module 402 (see FIG. 4), and the data may be dynamically presented based on data range 1512. The data on the dashboard may similarly be downloaded for offline use.

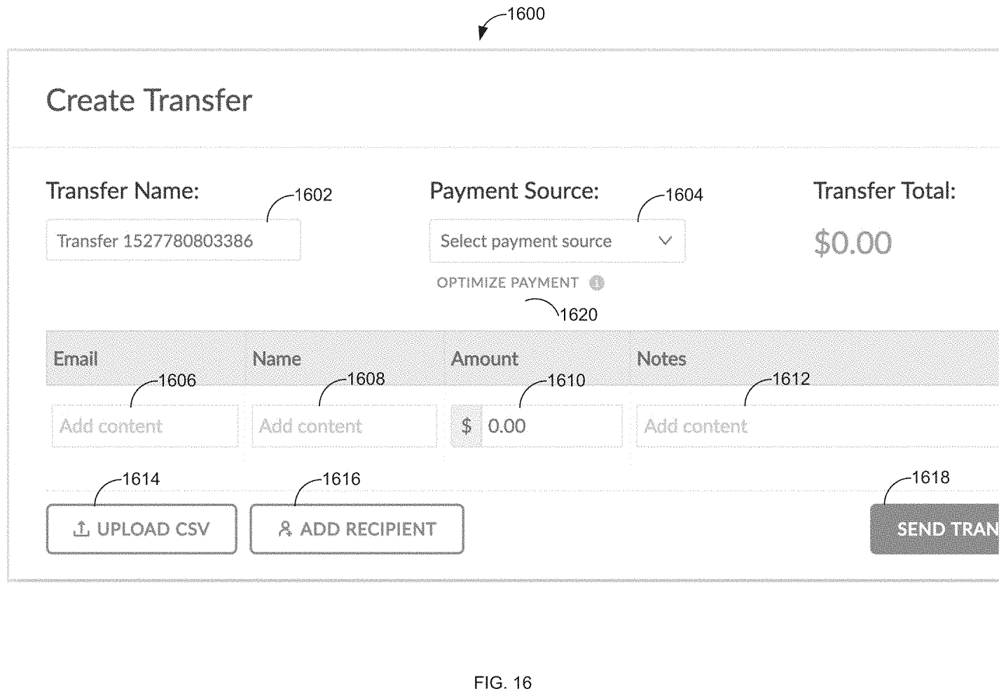

Referring to FIG. 16, there is shown a screenshot of a transfer request interface 1600. As referred to herein, a transaction request may also be referred to as a transfer request. The transfer request interface 1600 is used by a user to create a transfer request to send to the transaction router. A transaction request created by the transfer request interface may include a plurality of data comprising transaction data and transaction metadata. The transaction data may include data such as a transfer name 1602 selected by the payor, a plurality of recipient (payee) information including an email address 1606, a name 1608, an amount to send the recipient (payee) 1610, and a comment 1612. It will be recognized that other types of transaction data may be recorded and sent in the transaction request beyond what is shown.

Transaction metadata may also be collected when the transaction request is sent by a payor. This metadata may include the date and time of the transaction request, the geographic location of the payor, Other types of transaction metadata may also be sent in the transaction request.

The transaction request interface 1600 may allow a user to select a payment source 1604 to use as a source of the funds for the transaction, or the payor user may decide to allow the transaction router to make a routing decision automatically by selecting optimize payment 1620.

When the transaction request is sent (a user may click the send transfer button 1618), the transaction data and the transaction metadata are included and used by the transaction router to determine a routing decision.

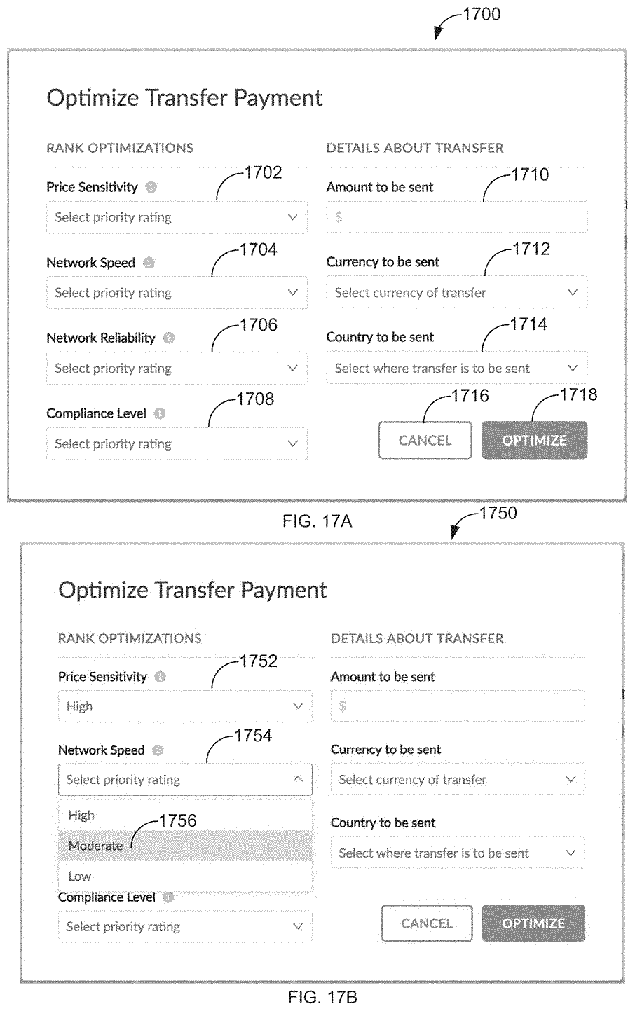

Referring to FIG. 17A, there is shown a screenshot of a payor preference interface. A payor user may specify certain preferences to be prioritized by the transaction router when making a routing decision. These may include at least price 1702, network speed 1704, network reliability 1706, compliance 1708, the currency of the transfer 1712 and the geographical destination of the payee 1714. The user may elect to have the transaction router determine the routing decision by clicking the optimize button 1718.

Referring to FIG. 17B, there is shown a screenshot of a user selecting a payor preference. In this case, the user may have several different options to select for the network speed preference 1754, including High, Moderate 1756, or Low. In this example, the user is selecting one option from the list, Moderate 1756. Other preference values may be used, including a radio button function yielding a Boolean yes/no option, a scale of preference from 1-10, a slider bar, or others as known in the art. These preferences may be used in a linear combination to determine an expected action score by the Markov Decision Process shown in FIG. 5.

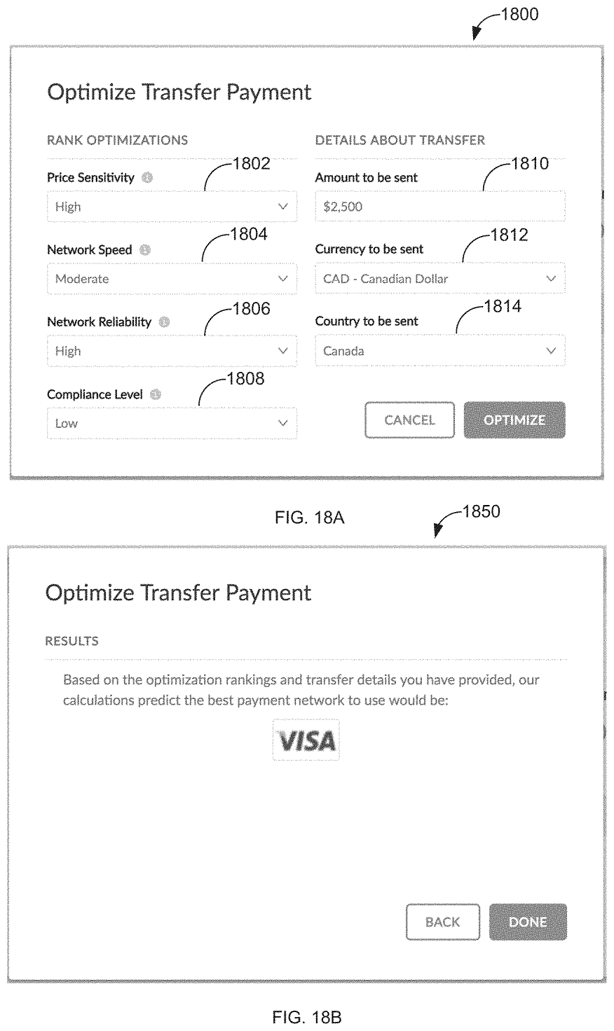

Referring to FIG. 18A, there is shown a screenshot of a completed payor preference interface 1800. In this example, the user has indicated a preference of High for price 1802, Moderate for network speed 1804, High for reliability 1806, Low for compliance 1808, and has specified that the amount 1810 should be transferred in Canadian dollars 1812 to a Canadian geographic destination 1814. It will be appreciated that this combination is simply for illustrative purposes and a user may select any combination of preferences.

Referring to FIG. 18B, there is shown a screenshot of the payor preference interface 1850, where a user is informed of the routing decision. The action to be taken in the form of a payment processing network is shown to process the transaction corresponding to the transaction request (in this example, VISA®).

Various embodiments have been described herein by way of example only. Various modification and variations may be made to these example embodiments without departing from the spirit and scope of the invention, which is limited only by the appended claims. Also, in the various user interfaces illustrated in the figures, it will be understood that the illustrated user interface text and controls are provided as examples only and are not meant to be limiting. Other suitable user interface elements may be possible.

We claim:

1. A method of routing a transaction at a server system from a client system to a destination payment network in a plurality of payment networks, the plurality of payment networks in network communication with the server system, comprising:
providing, at the server system, a machine learning routing model, the machine learning routing model comprising:
a plurality of states defining a state space, the state space having a plurality of dimensions;
a plurality of actions corresponding to the plurality of payment networks;
a plurality of state transition tables; and
at least one reward function,
receiving, from the client system, a transaction request, the transaction request comprising a plurality of data, wherein the plurality of data comprises transaction data and transaction metadata;
determining, at the server system, the destination payment network by:
determining a routing decision from the machine learning routing model based on the transaction request and the machine learning routing model, wherein the routing decision is determined based on the at least one reward function calculated for each action in the plurality of actions,
creating, at the server system, a transaction corresponding to the transaction request, the transaction comprising at least a payor, a payee, a transaction price, a transaction status, and a transaction time;
transmitting the transaction to the destination payment network corresponding to the routing decision.

2. The method of claim 1, further comprising:
creating, at the server system, a transaction response corresponding to the transaction request and a response of the destination payment network to the transaction; and
transmitting the transaction response to the client system.

3. The method of claim 2, further comprising:
storing, at a database of the server system, the transaction request, the transaction, and the transaction response.

4. The method of claim 3 wherein the state space has at least a price dimension corresponding to the transaction price, a network speed dimension corresponding to the transaction time, a reliability dimension corresponding to the transaction status, a compliance dimension, and a geographic dimension.

5. The method of claim 4 wherein each state transition table in the plurality of state transition tables comprises a plurality of state transition entries, each state transition entry describing a probability of a state transition from a first state to a second state for a given action.

6. The method of claim 5 wherein the determining the routing decision comprises:
for each action in the plurality of actions,
determining an expected action score via reinforcement learning;
selecting the action having the highest expected action score as the routing decision.

7. The method of claim 6 wherein the determining an expected action score further comprises evaluating Σₛ,Pₐ(s,s′)(Rₐ(s,s′)+γV(s′)), wherein Pₐ(s,s′) is a probability of an action transitioning a transaction from state s to s′, Rₐ(s,s′) is a reward of transitioning from state s to s′ calculated based on the at least one reward function, and γV(s′) is a discounted future action score.

8. The method of claim 7 further comprising determining the routing decision based on the at least one, each reward function being a weighted linear combination of state components.

9. The method of claim 8 wherein the machine learning routing model is modelled using a Markov Decision Process.

10. A transaction routing system for routing a transaction at a server system from a client system to a destination payment network in a plurality of payment networks, the plurality of payment networks in network communication with the server system, comprising:
a processor unit of the server system; and
a memory unit of the server system coupled to the processor unit, the memory unit storing instructions executable by the processor unit;
the processor unit being configured to:
provide a machine learning routing model, the machine learning routing model comprising:
a plurality of states defining a state space, the state space having a plurality of dimensions;
a plurality of actions corresponding to the plurality of payment networks;
a plurality of state transition tables; and
at least one reward function,
receive a transaction request from the client system, the transaction request comprising a plurality of data, wherein the plurality of data comprises transaction data and transaction metadata;
determine a routing decision from the machine learning routing model based on the transaction request and the machine learning routing model, wherein the routing decision is determined based on the reward score calculated based on the at least one reward function for each action in the plurality of actions;
create a transaction corresponding to the transaction request, the transaction comprising at least a payor, a payee, a transaction price, a transaction status, and a transaction time; and
transmit the transaction to the destination payment network corresponding to the routing decision.

11. The system of claim 10, wherein the processor is further configured to:
create a transaction response corresponding to the transaction request and a response of the destination payment network to the transaction; and
transmit the transaction response to the client system.

12. The system of claim 11, wherein the processor is further configured to:
storing, at a database in the memory unit, the transaction request, the transaction, and the transaction response.

13. The system of claim 12 wherein the state space has at least a price dimension corresponding to the transaction price, a network speed dimension corresponding to the transaction time, a reliability dimension corresponding to the transaction status, a compliance dimension, and a geographic dimension.

14. The system of claim 13 further comprising:
the processor unit being further configured:
wherein each state transition table in the plurality of state transition tables comprises a plurality of state transition entries, each state transition entry describing a probability of a state transition from a first state to a second state for a given action.

15. The system of claim 14 further comprising:
the processor unit being further configured:
wherein the determining the routing decision comprises:
for each action in the plurality of actions,
determining an expected action score;
select the action having the highest expected action score as the routing decision.

16. The system of claim 15 further comprising:
the processor unit being further configured to:
determine an expected action score further comprises evaluating Σₛ, Pₐ(s,s′)(Rₐ(s,s′)+γV(s′)), wherein Pₐ(s,s′) is a probability of an action transitioning a transaction from state s to s′, Rₐ(s,s′) is the reward of transitioning from state s to s′ calculated based on the at least one reward function, and γV(s′) is a discounted future action score.

17. The system of claim 16 further comprising:
the processor unit being further configured to:
determine the routing decision based on a weighted combination of state components.

18. The system of claim 17 wherein the machine learning routing model is modelled using a Markov Decision Process.

19. A method of creating a machine learning routing model for routing a transaction to a destination payment network in a plurality of payment networks at, comprising:
providing, in a database, a plurality of historical transactions;
creating, at the server system, a plurality of vector representations corresponding to the plurality of historical transactions;
creating, at the server system, a plurality of states defining a state space from the plurality of vector representations, and the state space having a plurality of dimensions;
sorting, at the server system, the plurality of vector representations into the plurality of states;
determining, at the server system, a plurality of state transition tables from the sorted plurality of vector representations, the plurality of state transition tables for routing a transaction based on a transaction routing decision to the destination payment network in the plurality of payment networks;
storing, in the database, the plurality of state transition tables.

20. The method of claim 19 wherein the state space has at least a price dimension corresponding to a transaction price, a network speed dimension corresponding to a transaction time, a reliability dimension corresponding to a transaction status, a compliance dimension, and a geographic dimension.

21. The method of claim 20 wherein each state transition table in the plurality of state transition tables further comprises a plurality of state transition entries, each state transition entry identifying a single probability of transition from an initial state s to a next state s′ for a given action.

22. The method of claim 21 further comprising:
determining a probability of a state transition entry by:
determining a number of historical transactions that have occurred between a state s and a state s′ for an action;
determining a total number of transactions associated with the action; and
dividing the number of historical transactions that have occurred between a state s and a state s′ by the total number of transactions associated with the action.

23. The method of claim 22 further comprising:
reducing the state space by removing states having zero transactions; and
reducing the number of states by combining states having generally similar components.

24. The method of claim 23 further comprising:
each of the plurality of historical transactions comprising:
transaction data;
transaction metadata; and
transaction status,
each vector representation in the plurality of vector representations is determined from a network speed data, a geographic data, a price data, a reliability data, and a compliance data from the plurality of historical transactions.

25. A machine learning routing model system for creating a machine learning routing model for routing a transaction to a destination payment network in a plurality of payment networks, comprising:
a processor unit;
a memory unit coupled to the processor unit, the memory unit storing instructions executable by the processor unit;
the processor unit being configured to:
provide a plurality of historical transactions;
create a plurality of vector representations corresponding to the plurality of historical transactions;
create a plurality of states defining a state space from the plurality of vector representations, and the state space having a plurality of dimensions;
sort the plurality of vector representations into the plurality of states,
determine a plurality of state transition tables from the sorted plurality of vector representations, the plurality of state transition tables for routing a transaction based on a transaction routing decision to the destination payment network in the plurality of payment networks; and
store the plurality of state transition tables.

26. The system of claim 25 wherein the state space has at least a price dimension corresponding to a transaction price, a network speed dimension corresponding to a transaction time, a reliability dimension corresponding to a transaction status, a compliance dimension, and a geographic dimension.

27. The system of claim 26 wherein each state transition table in the plurality of state transition tables further comprises a plurality of state transition entries, each state transition entry identifying a single probability of transition from an initial state s to a next state s′ for a given action.

28. The system of claim 27 wherein the processor unit is further configured to:
determine a probability of a state transition entry by:
determining a number of historical transactions that have occurred between a state s and a state s′ for the action;
determining the total number of transactions associated with the action,
divide the number of historical transactions that have occurred between a state s and a state s′ by the total number of transactions associated with the action.

29. The system of claim 28 wherein the processor unit is further configured to:
reducing the state space by removing states having zero transactions, and
reducing the number of states by combining states having generally similar components.

30. The system of claim 29 wherein:
each of the plurality of historical transactions comprising:
transaction data;
transaction metadata; and
transaction status,
each vector representation in the plurality of vector representations is determined from a network speed data, a geographic data, a price data, a reliability data, and a compliance data from the plurality of historical transactions.
